(19) United States
(12) Patent Application Publication
(10) Pub. No.: US 2019/0230948 A1
(43) Pub. Date: Aug. 1, 2019

(54) Fresh-Like Fruit with Extended Shelf Life

(71) Applicants: General Mills, Inc., Minneapolis, MN (US); Yoplait France SAS, Boulogne-Billancourt (FR)

(72) Inventors: Adam Ryszard Borysiak, Vienne (FR); Christine Ng, Minneapolis, MN (US); Maarten Stolk, CE Amersfoort (NL); Cynthia Berenice Marmolejo Garcia, AP Utrecht (NL); Cynthia Akkermans, PL Biddinghuizen (NL)

(73) Assignees: General Mills, Inc., Minneapolis, MN (US); Yoplait France SAS, Boulogne-Billancourt (FR)

(21) Appl. No.: 16/312,123

(22) PCT Filed: Jun. 13, 2017
(86) PCT No.: PCT/US2017/037216

§ 371 Date: Dec. 20, 2018

Related U.S. Application Data
(60) Provisional application No. 62/355,790, filed on Jun. 28, 2016.

(51) Int. Cl. A23B 7/148; A23B 7/08; A23B 7/155; A23B 7/157; A23B 7/16; A23L 3/015; A23B 7/005; A23C 9/133

(52) U.S. Cl. CPC A23B 7/148; A23B 7/085; A23B 7/155; A23B 7/157; A23V 2002/00; A23L 3/0155; A23B 7/005; A23C 9/133; A23B 7/16

(57) ABSTRACT

The present disclosure is directed to a method of treating delicate fruit with pressurized carbon dioxide to achieve an enhanced shelf life over fresh. A treated fruit produced by a provided method also has one or more of an improved flavor, improved, texture or improved color over a delicate fruit pasteurized using a thermal treatment.

### CROSS REFERENCE TO RELATED APPLICATIONS

This application claims the benefit of U.S. Provisional Patent Application Ser. No. 62/355,790, which was filed on Jun. 28, 2016 and titled “Fresh-Like Fruit with Extended Shelf Life”. The entire content of this application is incorporated by reference.

### BACKGROUND

Fresh fruit is a food enjoyed by many different cultures. However, delicate fruits, such as strawberries, blueberries, tomatoes, and peaches, are often only available seasonally due to their perishability. Even when fresh delicate fruits are made available by shipping from distant locations, those fruits are often picked under ripe in order to allow for shipping time, and the resulting product often lacks the desired flavor or texture of a locally grown, picked-ripe fruit.

Various methods have been developed to improve the shelf life of delicate fruits. Early methods include drying and canning. More recent developments include freezing and pasteurization. However, each of these affect the texture, flavor, and/or color of the fruit in exchange for a longer shelf life. For example, freezing results in tissue damage of the fruit, and once thawed, the fruit is often mushy and juices leak out. In addition, fruits that have been frozen can also exhibit a characteristic off-flavor. Drying results in a significantly altered texture of the fruit, as well as changes in color and flavor. Canning often relies on high sugar content, high salt content, or a reduced pH environment to preserve the fruit, and can affect flavor, texture, and color. Heat from elevated temperature pasteurization also affects color, flavor, and texture of soft fruits.

### SUMMARY

A method of producing a treated fruit is provided herein. The method includes exposing a firming mixture to carbon dioxide at a pressure between 35 bar and 300 bar to form a treated fruit composition, the firming mixture including a combination of one or more fruit firming compounds and a fresh or frozen delicate fruit, subjecting the firming mixture to a temperature greater than 0° C. and up to about 60° C., and depressurizing the treated fruit composition at a rate of depressurization selected to prevent substantial rupture of cell membranes to produce the treated fruit. The treated fruit can have a shelf life at 4° C. that is extended substantially beyond untreated fresh fruit of the same kind as the fresh or frozen fruit, and has a texture, color, or flavor that is improved compared to a control fresh or frozen fruit pasteurized using a thermal treatment alone or thermal treatment and a firming treatment over the shelf life at 4° C.

In some embodiments, the carbon dioxide is a liquid carbon dioxide. In some embodiments, the carbon dioxide is a supercritical fluid. In some embodiments, the pressure can be between 50 bar and 150 bar.

In some embodiments, the depressurization step can be done over a time period of 10 to 60 minutes. In some embodiments, the treated fruit composition can be depressurized to a pressure less than 74 bar. In some embodiments, the treated fruit composition can be depressurized to a pressure below atmospheric pressure.

In some embodiments, the firming mixture can be exposed to the carbon dioxide for 10 to 30 minutes.

In some embodiments, the step of subjecting the firming mixture to a temperature greater than 0° C. and up to about 60° C. is performed during all or part of the step of exposing a firming mixture to carbon dioxide at a pressure between 35 bar and 300 bar. In some embodiments, the step of subjecting the firming mixture to a temperature greater than 0° C. and up to about 60° C. is performed during all or part of the step of depressurizing the treated fruit composition.

In some embodiments, the one or more fruit firming compounds is included in a carrier fluid. In some embodiments, a method provided herein further includes a step of collecting the carrier fluid.

In some embodiments, the one or more fruit firming compounds include pectin methyl esterase, calcium chloride, pectin, sugar, or any combination of pectin methyl esterase, calcium chloride, pectin, and/or sugar. In some embodiments, the one or more fruit firming compounds are provided as a 0.2-1% calcium chloride solution in water, a 0.2-1% solution of pectin methyl esterase in water, or a combination of 0.2-1% calcium chloride and 0.2-1% pectin methyl esterase in water.

In some embodiments, a method provided herein further includes exposing the fresh or frozen fruit to the one or more firming compounds and a carrier fluid, and removing the carrier fluid. In some embodiments, the step of exposing the fresh or frozen fruit to the one or more firming compounds can be performed under vacuum.

In some embodiments, the treated fruit has a texture, color, or flavor that is improved compared to a control fresh or frozen fruit pasteurized using a pulsed electric field.

In some embodiments, the treated fruit is a whole fruit.

A method provided herein can be sufficient to achieve at least a 3 log reduction in E. coli or Listeria in the fruit.

In some embodiments, the treated fruit can maintain an improved texture over a shelf life at 4° C. of at least 3 weeks.

In some embodiments, the fresh or frozen delicate fruit can be non-transgenic. In some embodiments, the delicate fruit can be a soft fruit. In some embodiments, the delicate fruit can be a fruit exhibiting a soft, delicate interior or an edible plant part that exhibits a soft, delicate interior.

In some embodiments, the treated fruit can be a combination of two or more different delicate fruits treated together.

Also provided herein is a treated fruit having a shelf life at 4° C. that is extended substantially beyond untreated fresh fruit of the same kind as the treated fruit, and has a texture, color, or flavor that is improved compared to a control fresh or frozen fruit pasteurized using a thermal treatment over the shelf life at 4° C.

In some embodiments, the treated fruit product can have a shelf life of at least 3 weeks at 4° C.

In some embodiments, the treated fruit does not exhibit gelling over the shelf life.

In some embodiments, the treated fruit can have a respiration rate, as measured by O2 uptake, of less than 20% that of the untreated fresh fruit of the same kind.

In some embodiments, the treated fruit can be non-transgenic. In some embodiments, the delicate fruit can be a soft fruit. In some embodiments, the delicate fruit can be a fruit exhibiting a soft, delicate interior or an edible plant part that exhibits a soft, delicate interior.

In some embodiments, the treated fruit can be a combination of two or more different fruits.

Also provided is a food product that includes a treated fruit provided herein.

Also provided herein is a food kit that includes a treated fruit provided herein and a second food ingredient packaged together in separate containers or separate container compartments.

In some embodiments, a food product or food kit includes a treated fruit provided herein and a second food ingredient. In some embodiments, the second food ingredient is a fruit puree, a dairy product, or a grain-based product.

In some embodiments, a food product or food kit can include a treated fruit provided herein in a fermented dairy product, where the treated fruit has a texture that is improved over a fresh fruit of the same kind in the same type of dairy product over a shelf life at 4° C. and at least 2 weeks in the fermented dairy product. In some embodiments, the fermented dairy product includes a live and active culture.

In some embodiments, a food product or food kit provided herein can be a yogurt product, an ice cream product, a relish, a parfait, a coated fruit, or a snack bar.

Also provided herein are methods of collecting a natural color and/or flavor from a fruit. A method of collecting a natural color and/or flavor includes exposing a fruit mixture to carbon dioxide at a pressure between 35 bar and 300 bar to form a treated fruit composition, where the fruit mixture includes a carrier fluid and a fresh or frozen delicate fruit, subjecting the fruit mixture to a temperature greater than 0° C. and up to about 60° C., depressurizing the treated fruit composition at a rate of depressurization selected to prevent substantial rupture of cell membranes to produce the treated fruit, and collecting the carrier fluid from the treated fruit composition, the carrier fluid including the natural color and/or flavor.

In some embodiments, a method of collecting a natural color and/or flavor includes a step of concentrating the natural color and/or flavor. In some embodiments, a step of concentrating a natural color and/or flavor can include forward osmosis. In some embodiments, a method of collecting a natural color and/or flavor includes a step of concentrating the natural color and/or flavor. In some embodiments, a step of concentrating a natural color and/or flavor can be performed at a temperature of less than 50° C.

These and various other features and advantages will be apparent from a reading of the following detailed description.

### DRAWINGS

FIG. 1 shows photographs of strawberry pieces treated using methods provided herein.

FIG. 2 shows a photograph of a strawberry piece treated using a method provided herein (A), and photomicrographs of a thermally processed strawberry (B), a treated strawberry piece treated using a method provided herein (C), and a fresh strawberry (D).

FIG. 3 is a graph comparing texture of fresh strawberry to strawberries treated using various methods described herein.

FIG. 4 shows a photograph of fresh blueberries as compared to blueberries treated using methods provided herein.

FIG. 5 is a graph comparing texture of fresh blueberries to blueberries treated using methods described herein.

FIG. 6 shows a photograph of fresh raspberries as compared to blueberries treated using methods provided herein.

FIG. 7 is a graph comparing texture of fresh raspberries to raspberries treated using methods described herein.

FIG. 8 is a graph comparing O2 consumption of fresh cut strawberries and two varieties of strawberries treated using a method described herein.

FIG. 9 shows a photograph of fresh strawberry halves compared to whole and halved strawberries treated using methods described herein.

FIG. 10 shows photographs of carrier fluids from strawberries, raspberries, or blueberries treated using methods described herein (above), as well as yogurt white mass including the carrier fluids as a colorant (below).

### DETAILED DESCRIPTION

Delicate fruits are challenging to preserve because many treatments that reduce microbial load and/or activity can result in tissue damage of the fruit and/or activation of enzymes in the fruit that can modify the texture of the fruit. As used herein, the term “delicate fruit” refers to soft fruits lacking hard skins, other fruits that exhibit a soft, delicate interior, and edible plant parts that exhibit a soft, delicate interior. Soft fruits include, for example, strawberries, blackberries, blueberries, currants, raspberries, cranberries, other fruits from shrubs or bushes, and the like. Fruits and edible plant parts that exhibit a soft, delicate interior include grapes, tomatoes, peaches, apricots, plums, cucumbers, onions, peppers, avocado, bananas, and the like. Delicate fruits do not include apples, tree nuts, peanuts, coconuts, pears, leafy greens (e.g., lettuce, spinach, and the like), leafy herbs (e.g., basil, mint, and the like), and the like. As used herein, the term delicate fruit refers to whole fruits or solid pieces of delicate fruit, and not a fruit juice or mash.

As disclosed herein, it has been discovered that exposing a fresh or frozen delicate fruit to both a fruit firming compound and a pressurized carbon dioxide results in a treated fruit having improved shelf life over untreated fresh fruit. In addition, a method provided herein surprisingly results in a treated fruit that has improved texture, flavor, and/or color over a like fruit treated using a thermal treatment alone, or thermal treatment and a firming treatment.

As used herein, the term “fresh” refers to a delicate fruit that is whole, cut, washed, or unwashed, but has not otherwise been processed or had any additional treatment (e.g., added chemicals, irradiation, thermal treatment, and the like). A fresh delicate fruit can be at ambient temperature or refrigerated at a temperature above 0° C., unless otherwise indicated herein.

As used herein, the term “frozen” refers to a delicate fruit that is whole, cut, washed, or unwashed, and has been frozen to a temperature at or below 0° C. In some embodiments, frozen delicate fruit can be combined with one or more fruit firming compounds prior to freezing. A frozen delicate fruit has not otherwise been processed or had any additional treatment.

Fresh or frozen fruit may be combined with other fresh or frozen fruit and still be considered fresh or frozen for the purposes of this application. Comparisons between a treated fruit provided herein and fresh fruit refer to the same fruit in the same state (e.g., cut, whole, washed, unwashed, or combined with other fruit).

### Treated Fruit

A treated fruit is provided herein that has an extended shelf life as compared to an untreated fresh fruit of the same type. As used herein, “shelf life” refers to the time over which a food is safe to eat if stored at specific storage conditions. A treated fruit provided herein can have a shelf life at 4° C. that is improved substantially beyond an untreated fresh fruit of the same kind by at least 20%, at least 50%, or at least 100%. For example, if an untreated fruit has a typical shelf life at 4° C. of 10 days, in some embodiments, a treated fruit of the same kind provided herein can have a shelf life extended by at least 50%, or a total shelf life at 4° C. of at least 15 days. In some embodiments, a treated fruit provided herein has a shelf life at 4° C. that is at least 3 weeks (e.g., at least 4 weeks or at least 6 weeks). It is to be understood that comparison of shelf life between fresh fruit and treated fruit should be considered at 4° C. at normal atmosphere and without packaging. Shelf life can be extended through delicate fruit variety selection, atmospheric conditions, time of harvest of the delicate fruit, and packaging, as well as other factors.

A treated fruit provided herein also has at least one of an improved texture, an improved flavor, or an improved color over the same type of fruit that has been treated using a thermal treatment or a combination of a thermal treatment and a firming treatment.

As used herein, the term “thermal treatment” refers to exposure to a temperature greater than 60° C. and a time that results in pasteurization. Examples of thermal treatments include low temperature, long time (LTLT) pasteurization and high temperature, short time (HTST) pasteurization.

As used herein, a firming treatment is the exposure of a fruit to a fruit firming compound. A fruit firming compound can include any composition which firms a delicate fruit when the soft fruit is exposed to it. Examples of fruit firming compounds include, but are not limited to, pectin methyl esterase (PME), divalent ions (e.g., calcium chloride (CaCl₂)), magnesium chloride (MgCl₂), calcium lactate, and the like), pectin, sugar (e.g., sucrose, corn syrup, trehalose, honey, glucose, and the like), and combinations thereof. A firming compound can be included as a purified compound or as part of a natural source (e.g., a fruit puree, a milk ingredient, and the like).

An improved texture can include increased firmness when compared to a fruit treated using a thermal treatment or a thermal treatment in combination with a firming treatment. Firmness, as used herein, is the force required to bite into a delicate fruit. Firmness can be quantitatively measured using standard equipment and known methods. For example, in some embodiments, firmness can be measured using a TA.XT plus texture analyzer (Stable Micro Systems, Ltd., Surrey, United Kingdom). Briefly, a 50 kg load cell is attached to a TA.XT plus texture analyzer at a height of 30 mm. The TA.XT plus texture analyzer is further fitted with a Mini Kramer Shear cell (Stable Micro Systems). A sample to be measured is placed in the sample holder of the Mini Kramer Shear cell in an amount sufficient to line the bottom of the sample holder with one layer of the sample (about 14 g of sample). Multiple pieces can be used or the sample cut as necessary to line the bottom of the sample holder. Texture is measured by applying the “Button” setting with a trigger distance of 29 mm, a test speed of 1 mm/second, with the total duration of a single test being 29 seconds. Data is expressed as a curve of kg force over time in seconds. Firmness is measured as the average area in kg between the curve and a 10 g baseline up to peak force over 3 repetitions. As measured using a TA.XT plus texture analyzer, a treated fruit piece provided herein can have a firmness that is greater than the same type of fruit treated using a thermal treatment or a thermal treatment in combination with a firming treatment.

In some embodiments, fruit firmness can be qualitatively measured by biting and/or chewing using trained human subjects. In some embodiments, firmness of a treated fruit provided herein can be similar to an untreated fresh fruit after harvest and prior to significant softening.

In some embodiments, an improved texture can include increased crispness when compared to a fruit treated using a thermal treatment or a thermal treatment in combination with a firming treatment. Crispness, as used herein, is the peak force experienced during the first bite into a delicate fruit. As with firmness, crispness can be quantitatively measured using standard equipment and known methods. For example, in some embodiments, crispness can be analyzed using a TA.XT plus texture analyzer using the same method as described for firmness, except that crispness is measured as the average peak force in kg over 3 repetitions. As measured using a TA.XT plus texture analyzer, a treated fruit piece provided herein can have a crispness that is greater than the same type of fruit treated using a thermal treatment or a thermal treatment in combination with a firming treatment.

In some embodiments, fruit crispness can be qualitatively measured by biting using trained human subjects. In some embodiments, crispness of a treated fruit provided herein can be similar to an untreated fresh fruit after harvest and prior to significant softening.

In some embodiments, a treated fruit provided herein can exhibit a similar firmness and/or crispness to a fresh fruit of the same type. A treated fruit provided herein exhibiting a similar curve representing initial peak force (as described and measured above for crispness) and a similar curve of force over distance traveled (as described and measured above for firmness) to a fresh fruit of the same type would be expected to exhibit a similar eating experience to the fresh fruit with regard to texture.

In some embodiments, a treated fruit provided herein can have improved flavor over a like fruit treated using a thermal treatment alone, or thermal treatment and a firming treatment. Improved flavor can include increased flavor intensity, increased fresh fruit flavor, decreased cooked fruit flavor, decreased off-notes, and the like. In some embodiments, compounds that impart desired (e.g., fresh fruit notes) or undesired (e.g., cooked notes, off-flavors) flavor characteristics can be measured using, for example, gas chromatography-mass spectrometry to quantitatively determine flavor quality.

In some embodiments, flavor improvement can be qualitatively measured by a panel of individuals trained to detect flavor components in foods.

In some embodiments, a treated fruit provided herein can have improved color over a like fruit treated using a thermal treatment alone, or thermal treatment and a firming treatment. Improved color can include increased color intensity and/or a hue that better resembles a fresh fruit of the same kind. Color improvement can be quantitatively measured using known techniques and equipment. For example, color intensity and hue can be measured using a spectrophotometer. Homogeneous samples are measured in a glass cell adapted to spectrocolorimetry using a CM 3500d spectrophotometer (Minolta Co. Ltd., Japan) with SpectraMagic NX Pro software (Color Data Software CM-S100w, Konica Minolta Inc., 1895-153 Version 2.5). Homogeneous samples are produced by homogenizing a treated fruit or corresponding reference sample (e.g., fresh fruit, heat treated fruit, frozen fruit). Homogeneous samples are measured at about 10° C. in D65 daylight. Each of the following parameters can be measured using spectrocolorimetry: lightness (L), red/green value (a), blue/yellow value (b), hue (h), and color intensity (i.e., chroma; C). Lightness is measured as a value between 0 and 100. Red/green value and blue/yellow value are each measured as a value between −60 and 60. Hue is measured as a value between 0° and 180°. Chroma is measured as a value between 0 and 60. Lightness, red/green value, blue/yellow value, hue, and chroma can be compared between a treated fruit and any appropriate reference, such as a fresh fruit, a frozen fruit, or a heat treated fruit. In some embodiments, color improvement can be qualitatively measured by direct human observation.

In some embodiments, a method provided herein can also provide a treated fruit that has a texture, color, and/or flavor that is improved over other treatments, such as pulsed electric field treatment, or freezing. For example, pulsed electric field treatment sufficient to pasteurize delicate fruit would result in the piece or whole delicate fruit being structurally damaged. In another example, freezing and thawing of a delicate fruit can result in structural damage, as well as changes in flavor and/or color.

A treated fruit provided herein can have a respiration rate, as measured by O₂ uptake, that is significantly less than that of an untreated fresh fruit of the same kind. O₂ uptake can be measured by filling a hermetically sealed container about ⅓ to ½ full with a treated fruit that is pre-chilled to 4° C. The container is then stored at 4° C. and the atmosphere within the container is sampled at 0 hours, 24 hours, 48 hours, 72 hours, and 96 hours. The atmosphere in the container can be sampled using any appropriate means so long as the atmosphere in the container is not contaminated with outside air. For example, a septum can be included on the container that allows for a needle to be inserted to sample air. A second container is similarly filled with untreated fresh fruit of the same kind, placed at 4° C., and sampled at the same time points. The amount of O₂ in each sample is then measured and compared to O₂ uptake of the untreated fresh fruit.

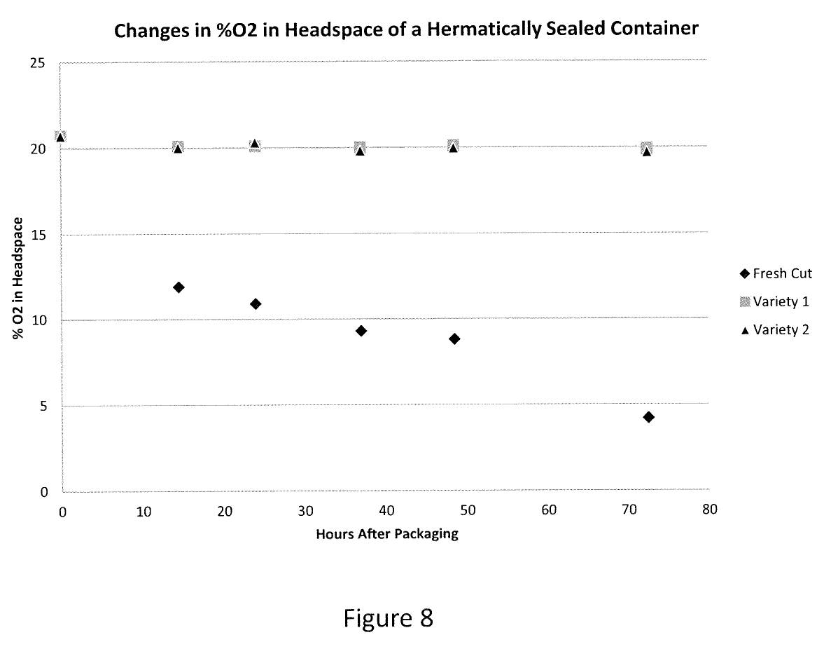

The respiration rate of a treated fruit provided herein, as measured by O₂ uptake, is significantly less than an untreated fruit of the same kind if the amount of O₂ taken up by the treated fruit is at least 20% less (e.g., at least 50% less or at least 90% less) than that taken up by the untreated fresh fruit at 96 hours. For example, as illustrated in FIG. 8, treated strawberry pieces reduced the O₂ in the atmosphere of a hermetically sealed container by 1.2% or less (from 20.7% to 19.8% for variety 1, and from 20.7% to 19.5% for variety 2), while fresh strawberry pieces reduced the O₂ in the atmosphere of a hermetically sealed container by about 18.9% (20.7% to 1.8%). In this example, the O₂ consumption of the treated strawberry pieces was about 95% less for variety 1 (100−(0.9/18.9)*100=95.2%) and about 94% less for variety 2 (100−(12/18.9)*100=93.7%).

In some embodiments, a treated fruit provided herein exhibits little to no gelling during the shelf life of the treated product. Gelling can be observed as the presence of jelly-like substance on an external surface of the treated fruit. Gelling may not be readily observed if the treated fruit is stored in a liquid, such as a fruit puree or mash.

### Methods

A method for producing a treated fruit provided herein includes exposing a firming mixture to carbon dioxide for a time and at a temperature sufficient to produce a treated fruit composition. Methods disclosed herein include the use of a liquid or supercritical fluid carbon dioxide that is at a pressure between 35 bar and 300 bar (e.g., between 50 bar and 150 bar) and a temperature of above 0° C. up to about 60° C. (e.g., between 10° C. and 45° C. or between 20° C. and 40° C.). In some embodiments, a carbon dioxide is a supercritical fluid, which is at a temperature above 31° C. and a pressure above 74 bar.

As used herein, a firming mixture includes one or more fresh or frozen delicate fruits in combination with one or more fruit firming compounds. In some embodiments, a fruit firming compound can be included in a firming mixture in a carrier fluid, such as a fruit puree or mash, or water. For example, a fruit firming compound can be provided in a firming mixture as a solution in water or other carrier. In some embodiments, one or a combination of CaCl₂) and PME can be provided as a solution at a concentration of from 0.2% to 1% (e.g., 0.2% to 0.75%) each in water or a fruit puree.

In some embodiments, a fresh or frozen fruit used in a method provided herein can be non-transgenic and/or organically grown. In some embodiments, a fresh or frozen fruit can be treated using a method provided herein as a combination of different delicate fruits.

The time that a firming mixture is exposed to carbon dioxide can be from about 10 minutes to about 30 minutes (e.g., 10 to 15 minutes or 10 to 20 minutes) can be used to produce a treated fruit. The time that a firming mixture is exposed to carbon dioxide can be adjusted based on temperature of exposure, and vice versa. For example, a lower amount of time can be coupled with a higher temperature within the disclosed range, or a higher amount of time can be coupled with a lower temperature. In some embodiments, a time of exposure to carbon dioxide can exceed 30 minutes, so long as at least one of desired characteristics of the treated fruit as described above is achieved.

The firming mixture is also subjected to a temperature between 0° C. and 60° C. during exposure to carbon dioxide. In some embodiments, such as with a delicate fruit that is prone to flavor changes at higher temperatures (e.g., strawberries), a temperature of between 10° C. and 40° C., or between 20° C. and 35° C. is preferred. Delicate fruits that have flavors that are less sensitive to temperature can be exposed to temperatures at the higher end of the range without impacting flavor. However, in some embodiments, flavor modification due to a temperature closer to 60° may not be a problem, and a higher temperature within the range can still achieve a texture benefit over a thermal treatment that exceeds 60° C.

In some embodiments, the firming mixture can be exposed to a temperature between 0° C. and 60° C. before or after exposure to carbon dioxide (e.g., during pressurization or depressurization), as well as during. Similarly, in some embodiments, the firming mixture can be exposed to carbon dioxide below a temperature of 20° C. However, it is to be understood, that the combination of time and temperature during exposure to carbon dioxide should be sufficient to achieve at least one of the desired characteristics of the treated fruit as described above.

It is to be understood that the temperature and/or pressure need not remain steady during the entire exposure time to carbon dioxide according to a method provided herein. However, in one embodiment, a firming mixture is exposed to carbon dioxide for a period of about 10 minutes to about 30 minutes at a peak temperature and peak pressure during treatment. For example, a method provided herein can include exposure of a firming mixture to carbon dioxide at a pressure of 50 bar to 150 bar and a temperature between 20° C. and 35° C., where the firming mixture is exposed to carbon dioxide at 150 bar (peak pressure) and 35° C. (peak temperature) simultaneously for 10 to 30 minutes.

In another embodiment, a firming mixture can be exposed to a selected range of pressures and/or temperatures over a period of about 10 minutes to about 30 minutes. For example, a method provided herein can include exposure of a firming mixture to carbon dioxide at a pressure that increases from 120 bar to 150 bar and a temperature that remains at 30° C. over a period of 10 minutes to 30 minutes.

Following exposure to carbon dioxide, a treated fruit composition is depressurized at a rate selected to prevent substantial rupture of cell membranes to produce a treated fruit. The rate can be adjusted based on the delicate fruit that has been treated. In addition, the rate can be adjusted depending on the final pressure desired. A rate of about −30 bar/minute to about −1 bar/minute (e.g., about −15 bar/minute to −1 bar/minute) can be selected. In some embodiments, depressurization to atmospheric pressure can take place over a period of about 10 minutes to about 60 minutes (e.g., about 20 minutes to about 45 minutes).

In some embodiments, depressurization can be stopped at a pressure above atmospheric pressure. A pressure above atmospheric temperature can be used in certain packaging configurations or to assist in pumping of the treated fruit.

In some embodiments, a treated fruit can be depressurized to a pressure that is below atmospheric pressure. A pressure below atmospheric pressure can be used in certain packaging configurations or to achieve further benefits, such as reducing off gassing of carbon dioxide after treatment.

In some embodiments, a firming mixture can be treated according to a disclosed method in a carrier fluid, such as water or a fruit puree or mash. Following treatment, the carrier fluid can remain with the treated fruit or be collected. A collected carrier fluid can contain excess firming compound, or can be used to capture any natural color or flavor released by the delicate fruit during treatment.

A carrier fluid containing a natural color or flavor captured using a method provided herein can be used to add color or flavor to a food product. Thus, a method for collecting a natural color or flavor from a delicate fruit is provided herein.

In some embodiments, a carrier fluid can be used without further treatment to reduce microbial contamination (e.g., by thermal pasteurization or filtration), or to increase concentration of a natural color or flavor therein. For example, a collected carrier fluid from treated strawberries can be used to add a red color to a yogurt white mass or ice cream.

In some embodiments, a carrier fluid can be subjected to a treatment that concentrates a natural color or flavor contained therein. For example, a carrier fluid can be fully or partially dewatered using a forward osmosis method (e.g., described in U.S. Pat. No. 8,181,794, U.S. Patent Publication 2012/0080378, and incorporated in their entireties herein) in order to concentrate a natural color and/or flavor in the carrier fluid. Other methods of concentrating a natural color or flavor include, without limitation, distillation, evaporation, sublimation, freeze concentration, ultrafiltration, nanofiltration, reverse osmosis, and the like. In some embodiments, a concentration method can be performed at a temperature of less than 50° C. (e.g., at 40° C. or less), which can reduce heat-induced degradation of a natural color and/or flavor being concentrated.

In some embodiments, a carrier fluid containing a natural color and/or flavor, or a natural color and/or flavor concentrated from a carrier fluid, can be stable (i.e., show insignificant change in hue and/or intensity) over a shelf life of at least 10 days (e.g., at least 2 weeks, at least 3 weeks, or at least 6 weeks) at 4° C. In some embodiments, a carrier fluid containing a natural color and/or flavor, or a natural color and/or flavor concentrated from a carrier fluid, can be stable in a food product described herein over a shelf life of at least 10 days (e.g., at least 2 weeks, at least 3 weeks, or at least 6 weeks) at a typical storage temperature for the food product (e.g. about 4° C. for a refrigerated food product, 0° C. or less for a frozen food product, or more than 10° C. for a non-frozen, non-refrigerated food product).

In some embodiments, a fresh or frozen fruit can be exposed to a firming mixture in a carrier fluid that is removed prior to exposing to carbon dioxide.

In some embodiments, a firming mixture can be exposed to a vacuum prior to exposure to carbon dioxide. Vacuum exposure can be used to infuse a firming compound or other compound into a delicate fruit prior to carbon dioxide exposure. However, it has been discovered that vacuum exposure does not need to be performed to provide the desired texture benefits.

In some embodiments, a method provided herein can achieve at least a 3 log reduction (e.g., at least a 4 log reduction) of E. coli or Listeria in a delicate fruit. In some embodiments, a method provided herein can achieve at least a 1 log reduction (e.g., at least a 2 log reduction) in a fungus (e.g., Byssochlamis fulvus) or a yeast in a delicate fruit.

In some embodiments, a carrier fluid containing a natural color and/or flavor, or a natural color and/or flavor concentrated from a carrier fluid, can contain few or an undetectable number of viable microbes even without further treatment to reduce microbial contamination.

In some embodiments, a method provided herein can achieve a reduction in activity of one or more enzyme (e.g., pectin methyl esterase (PME), polygalacturonase (PG), peroxidase (POD), or polyphenol oxidase (PPO)) in a delicate fruit. In some embodiments, enzyme activity can be reduced by at least 10% (e.g., 15-60%) in a treated fruit as compared to a fresh fruit of the same kind. For example, PME activity can be reduced by at least 30%, PG activity can be reduced at least 25%, POD activity can be reduced by at least 20%, and/or PPO activity can be reduced by at least 10% in strawberries. It is to be understood that enzyme activity in any given delicate fruit type or variety within a delicate fruit type may vary and that comparison is between a treated fruit and the like fruit type and variety harvested at the same time and at the same maturity. PG activity can cause softening during ripening of fruit. It is believed that, in some embodiments, reduction in PG activity can increase shelf life of a treated fruit and/or firmness of a treated fruit over shelf life. PME can cause gelling of fruit over time. It is believed that, in some embodiments, reduction in PME activity can reduce undesired gelling during shelf life of a treated fruit. PPO can cause browning in presence in oxygen. It is believed that, in some embodiments, reduction in PPO activity can reduce discoloration of treated fruit during shelf life. POD activity can be used for a marker for evaluating thermal treatment effectiveness. It is believed that, in some embodiments, reduction in POD activity can be used as a marker to evaluate whether additional enzymes may be inactivated following a treatment provided herein.

The methods described herein can be performed using any appropriate equipment. For example, a method provided herein can be performed in any vessel or piping system that can withstand the temperatures and pressures required to perform the method. Equipment used in a method provided herein should be safe for use with food, such as stainless steel pressure vessels and other equipment that can be readily sterilized.

Following treatment, a treated fruit can be packaged or further processed to make food products. Packaging can be bulk or pre-portioned packaging. In some embodiments, a delicate fruit can be packaged in a CO₂ permeable package prior to treatment, and the resulting treated fruit can be retained in the CO₂ permeable package, or redistributed into new packaging.

### Products

In some embodiments, the methods and treated fruit described herein can be used in the production of various food products. Examples of food products include treated fruit packaged on its own or combined with one or more other food ingredients. Any appropriate food products can be made using a treated fruit provided herein. Examples of appropriate foods include frozen foods (e.g., ice cream, sherbet, sorbet, coconut milk-based frozen desserts, and the like), refrigerated foods (e.g., parfaits, salsas, refrigerated fruit snacks, sweet and savory yogurts, cheeses, and the like), and other foods (e.g., baked goods, snack bars, oatmeal, Mexican foods, and the like).

A treated fruit can be used as, or in, a relish, such as salsa, cucumber relish, or fruit relish, or fresh-like salad, such as a fruit salad. A treated fruit relish can include fruits that were treated together or separately, and can be sold packaged in any suitable format, including, for example, jars, cans, packets, or clam shell packaging. Packaging can be made from any suitable material, such as plastic, glass, foil, or the like.

In some embodiments, a treated fruit can be combined with a fermented dairy ingredient, such as yogurt, cheese, or kefir. Such a food product can have a longer shelf life than a fermented dairy-based food product including fresh fruit. Food products that include a treated fruit and a fermented dairy ingredient include, for example, parfaits, fruit-on-the-bottom yogurt, blended yogurt, kefir with treated fruit pieces, fresh-like fruit coated with a yogurt-based coating, cream cheese with fruit, cottage cheese with fruit, and frozen yogurt. In some embodiments, a food product including a fermented dairy ingredient can include a live and active culture.

In some embodiments, a treated fruit can be combined with a non-fermented dairy ingredient, such as milk, ice cream, or whipped cream to produce a food product. Such a food product can have a longer shelf life than a dairy-based food product including fresh fruit. Food products that include a treated fruit and a non-fermented dairy ingredient include, for example, parfaits, ice cream, and flavored milk.

As used herein, the term “dairy ingredient” refers to bovine and non-bovine milk-based ingredients, including lactose-free variants, as well as dairy substitutes, including plant-based (e.g., nut- or legume-based) milks, yogurts, cheeses, and the like.

In some embodiments, a treated fruit can be combined with a second fruit ingredient, such as a fruit puree, a fruit juice, or a fruit mash, to produce a food product. In some embodiments, a second fruit ingredient can be treated using carbon dioxide in the presence or separately from the treated fruit. In some embodiments, a second fruit ingredient can be pasteurized using a thermal or other treatment (e.g., pulsed electric field).

In some embodiments, a treated fruit can be combined with a grain ingredient, such as rolled oats, flour, or whole grain to produce a food product. Examples of such food products include oatmeal, snack bars, and parfaits.

Other ingredients that can be combined with a treated fruit include, for example, chocolate, fat-based coatings, nut ingredients, and the like.

In some embodiments, a treated fruit can be packaged with one or more additional food ingredient in separate containers or separate container compartments. For example, a treated fruit can be packaged together with a yogurt in a separate container or container compartment and be combined just before or during consumption. In other examples, a treated fruit can be packaged in a separate compartment or container with a shelf-stable or refrigerated dough or batter-based product (e.g., cake mix, taco shell or tortilla, pancake batter, refrigerated dough, or the like).

### EXAMPLES

### Example 1

Fresh strawberries were cut into 8 pieces each and subjected to one of the treatments set forth in Table 1. Vacuum infusion, if done, was performed prior to CO₂ treatment by placing the firming mixture (fresh fruit plus the fruit firming compound in Table 1) in a glass vacuum chamber and applying vacuum for 5 minutes at a pressure of −15 inches Hg. Where noted in Table 1, fruit was treated with CO₂ in a carrier liquid, which was a solution of the fruit firming compound, at either a 1:1 ratio of fruit to carrier liquid or a 2:1 ratio of fruit to carrier liquid. In condition 4, following vacuum infusion, liquid containing excess fruit firming compound was removed prior to the CO₂ treatment. In condition 1, following vacuum infusion, the entire mixture of firming compound and fruit was treated with CO₂. CO₂ treatment was done at 35° C., 120 bar, for 15 minutes in a stainless steel chamber. If no vacuum infusion was performed, the firming mixture was placed directly in the CO₂ treatment chamber. Following CO₂ treatment, samples were depressurized to atmospheric pressure over 45 minutes. It should be noted that in this Example and the following examples, the time of CO₂ treatment is the time at which the fruit is treated at the full pressure and temperature indicated. Pressure and/or temperature may be elevated above ambient during all or part of pressurization and/or depressurization of the treatment vessel. Thus, a fruit treated with a 15 minute CO2 treatment at 35° C. and 120 bar, followed by depressurization to atmospheric pressure over 45 minutes may actually be at a temperature of 35° C. for 60 minutes or longer, and a pressure between atmospheric pressure and 120 bar for 45 minutes or longer.

TABLE 1

| | | | | Fruit to |
|---|---|---|---|---|
| | Fruit Firming | Vacuum | Carrier | Carrier Ratio |
| Condition | Compound | infusion | Liquid | by Weight |
| 1 | 17% sucrose | Yes | Yes | 1:1 |
| | solution | | | |
| 2 | Strawberry | No | Yes | 1:1 |
| | puree:sugar | | | |
| | (7:1 ratio) | | | |
| 3 | Strawberry | No | Yes | 2:1 |
| | puree:sugar | | | |
| | (7:1 ratio) | | | |
| 4 | Strawberry | Yes | No | NA |
| | puree:sugar | | | |
| | (7:1 ratio) | | | |

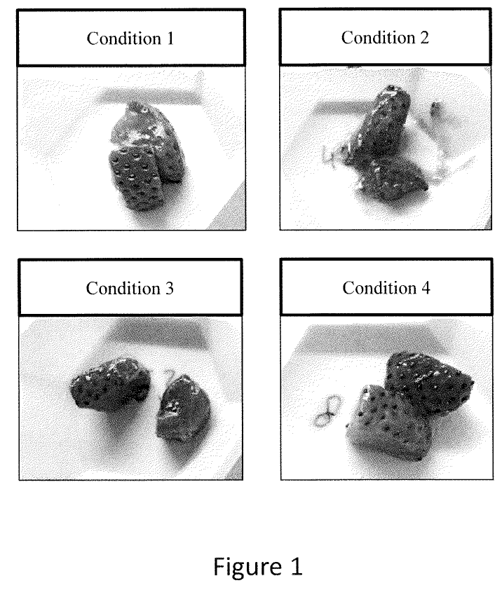

Samples in each of the treatment conditions described in Table 1 were qualitatively analyzed using human subjects. Treatment conditions 1 and 4 resulted in strawberry pieces with an appearance, texture, and flavor most resembling fresh, with condition 4 resulting in a slightly more acidic flavor than treatment condition 1. Treatment condition 2 resulted in strawberry pieces that were soft and with limited crispiness. The flavor of treatment condition 2 was sweeter than the other treatment conditions, and was the least firm with a texture that resembled a natural jam. The color of treatment condition 2 was similar to fresh strawberry. Treatment condition 3 resulted in a color resembling fresh strawberry, and had little drip loss. The flavor and texture were acceptable, with a good flavor and sweetness. Samples from treatment condition 3 was more firm and crispy than treatment condition 2, but not quite as close to fresh as samples from treatment conditions 1 and 4. FIG. 1 shows samples from each of the conditions in Table 1.

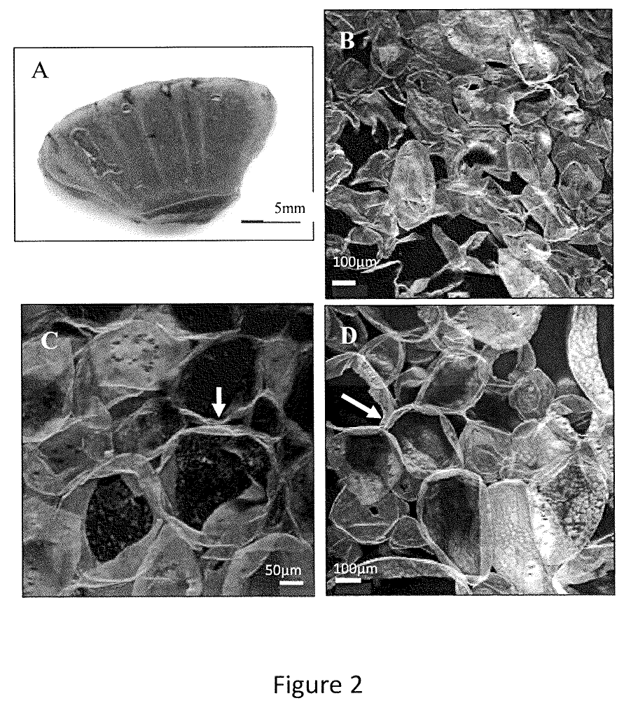

A second experiment was conducted using conditions similar to treatment condition 2 from Table 1, except that the fruit firming compound and carrier liquid were strawberry puree:sugar at a 5:1 ratio. A macroscopic image (shown in FIG. 2A) of a treated strawberry was produced by scanning ¼ inch slices of a treated strawberry piece on an Epson V700 Photographic Scanner (Epson, Long Beach, Calif., USA). Photomicrographs of the treated strawberry pieces from the second experiment were prepared by cross sectioning treated pieces with a double edged razor blade, staining with 0.01% calcofluor white M2R, and imaged using an Olympus Fluoview 1000 confocal microscope (Olympus Scientific Solutions Americas Corp., Waltham, Mass., USA) using a 10× objective (FIGS. 2B and 2D) or a 20× objective (FIG. 2C). Thermally processed strawberry pieces treated by exposure to steam for 3 minutes. FIG. 2 compares micrographs of a thermally processed strawberry in B, as compared to a treated fruit in C, and a fresh strawberry in D. It can be observed that a thermally processed strawberry shows cell structure damage, with collapsed cells and some cells exhibiting large spaces between neighboring cells. In contrast, the cells in the treated strawberry sample are more open and maintain a tight middle lamella between cells. White arrows in FIGS. 2C and 2D identify middle lamellae.

### Example 2

Fresh strawberries were diced and subjected to one of the treatments set forth in Table 2. Vacuum infusion, if done, was performed prior to CO₂ treatment as described in Example 1. Where noted in Table 2, fruit was treated with CO₂ in a carrier liquid, as indicated, at a 1:1 ratio of fruit to carrier liquid. CO₂ treatment was done at 35° C., 120 bar, for 15 minutes in a stainless steel chamber. Following CO₂ treatment, samples were depressurized to atmospheric pressure over 45 minutes.

TABLE 2

| | Fruit Firming | Vacuum | Carrier |
|---|---|---|---|
| Condition | Compound | infusion | Liquid |
| 2A.1 | 1% CaCl₂/ | Yes | Water |
| | 1% PME | | |
| 2A.2 | 0.5% CaCl₂ | Yes | Water |
| 2A.3 | 0.25% CaCl₂/ | Yes | Water |
| | 0.25% PME | | |
| 2A.4 | 0.5% CaCl₂/ | Yes | Water |
| | 0.5% PME | | |
| 2A.5 | 0.5% CaCl₂/ | No | 0.5% CaCl₂/ |
| | 0.5% PME | | 0.5% PME |
| 2A.6 | 0.5% CaCl₂/ | Yes | None |
| | 0.5% PME | | |

Texture, including firmness and crispness, were evaluated using a TA.XT plus texture analyzer and the methods described above, except with only one repetition due to sample quantity available. The results are shown in Table 3.

TABLE 3

| | Firmness | Crispness |
|---|---|---|
| Condition | (kg) | (kg) |
| 2A.1 | 3.31 | 14.95 |
| 2A.2 | 1.46 | 4.18 |
| 2A.3 | 2.09 | 6.75 |
| 2A.4 | 3.57 | 10.79 |
| 2A.5 | 3.68 | 12.28 |

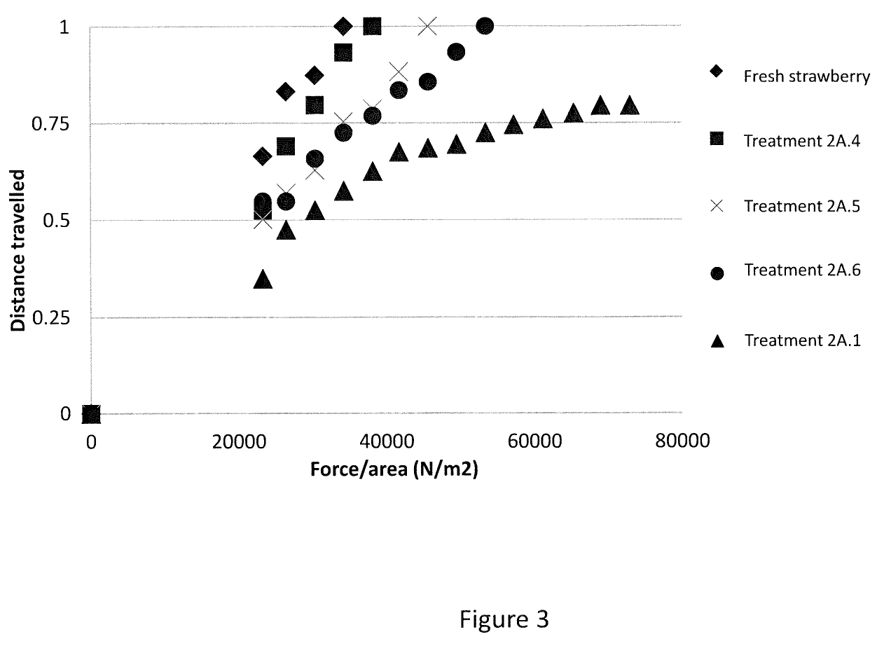

A graph was produced using a second texture analysis method that measures the slope of distance that a round probe traveled through a piece of treated fruit or control fruit over force/area. Briefly, a single piece of diced fruit was placed on a platform and a penetrometer with no weight applied was placed on the piece. The initial distance of the penetrometer from the platform was measured. The distance traveled by the penetrometer with the incremental addition of 10-11 g weight to a load cell was measured until the penetrometer reached the platform. Weight was converted to a gravitational force and then divided by the surface area of the circular probe used. A curve was plotted showing the correlation of distance traveled over force applied averaged over 3 pieces, and is provided in FIG. 3. As can be seen in FIG. 3, CO₂ treatment with or without vacuum infusion can produce a treated fruit with close similarity in texture to fresh, with a solution of 0.5% PME/0.5% CaCl₂ as a fruit firming compound producing results closer to fresh than 1% PME/1% CaCl₂. In addition, similar results were produced whether the fruit was treated with CO2 in the presence or absence of a liquid carrier.

Samples produced using the conditions from Table 2 were evaluated for color intensity and hue using a CM 3500d spectrophotometer (Minolta Co. Ltd., Japan) with SpectraMagic NX Pro software (Color Data Software CM-S100w, Konica Minolta Inc., 1895-153 Version 2.5) as described above. Results of the spectrophotometer analysis are shown in Table 4.

TABLE 4

| | | Red/green | Blue/yellow | | |
|---|---|---|---|---|---|
| Condition | Lightness | value | value | Hue | Chroma |
| 2A.1 | 41.24 | 29.55 | 16.86 | 34.02 | 29.71 |
| 2A.2 | 42.42 | 33.19 | 18.03 | 37.77 | 28.51 |
| 2A.3 | 40.5 | 37.52 | 21.21 | 43.1 | 29.48 |
| 2A.4 | 39.17 | 36.23 | 20.38 | 41.57 | 29.36 |
| 2A.5 | 37.94 | 36.51 | 22.59 | 42.93 | 31.75 |
| Fresh control | 33.91 | 40.86 | 24.74 | 47.76 | 31.2 |

As can be seen in Table 4, treatment conditions 2A.3, 2A.4, and 2A.5 produced treated strawberries with color that most closely resembled fresh strawberry.

### Example 3

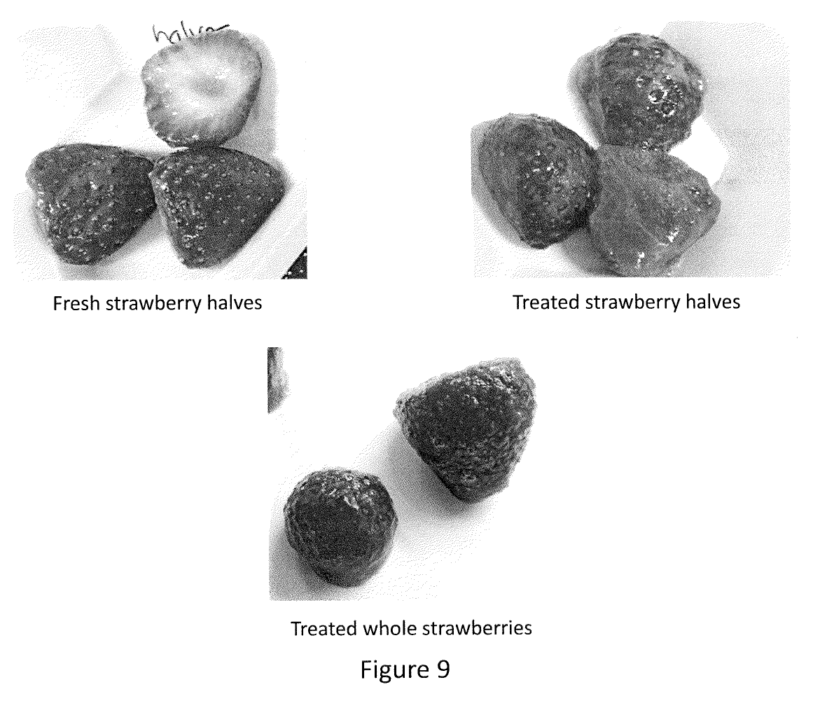

An experiment was performed using fresh halved or whole strawberries with the green tops removed. The halved or whole strawberries were treated in a strawberry puree:sugar (5:1) firming compound using liquid CO₂ at 11° C. and 53 bar for 15 minutes, followed by depressurization to atmospheric pressure over a period of 30 minutes. Images were taken of the treated strawberries are shown in FIG. 9. Following a storage period of 3 weeks at 10° C., no microbial contamination was observed, and were observed to be unspoiled upon consumption.

### Example 4

Fresh whole blueberries were subjected to one of the treatments set forth in Table 5. CO₂ treatment was done at the temperature indicated in Table 5, 120 bar, for 15 minutes in a stainless steel chamber. Following CO₂ treatment, samples were depressurized to atmospheric pressure over the time indicated in Table 5. No vacuum infusion was used.

TABLE 5

| | Firming | | Depressurization | |
|---|---|---|---|---|
| Condition | compound | Temperature | time | |
| 2D-1 | 0.5% PME/ | 35° C. | 45 | minutes |
| | 0.5% CaCl₂ | | | |
| 2D-2 | 1% PME/ | 45° C. | 60 | inutes |
| | 1% CaCl₂ | | | |

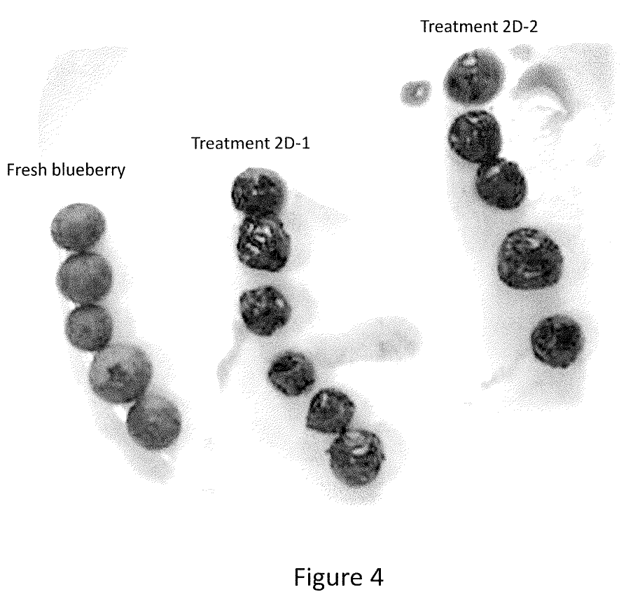

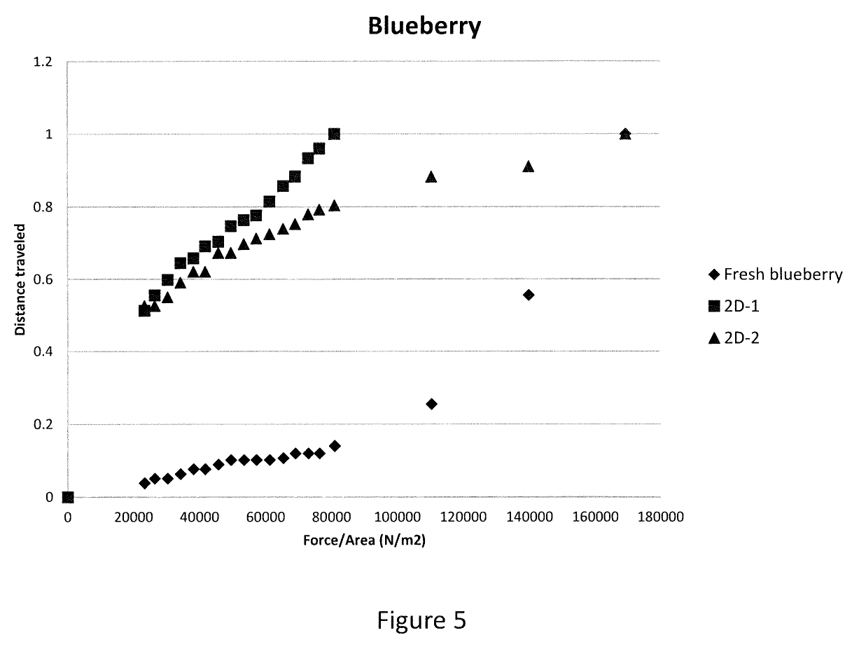

The second texture analysis method from Example 2 was used to produce FIG. 4. FIG. 4 shows fresh blueberries and blueberries treated according to Table 5. As can be seen in FIG. 4, treatment condition 2D-2 produced a more plump looking blueberry than treatment condition 2D-1. Similarly, as can be seen in FIG. 5, treatment condition 2D-2 produced treated blueberries with texture properties that most closely resembled the fresh blueberry control. In both treatment conditions 2D-1 and 2D-2, the treated blueberries had a good blueberry flavor and eating experience when stored in a liquid. It is theorized that the skins of the treated blueberries were rendered somewhat permeable by treatment, allowing juices to leak from the berries.

### Example 5

Fresh whole raspberries were subjected to one of the treatments set forth in Table 6. CO₂ treatment was done at 35° C., 120 bar, for 15 minutes in a stainless steel chamber. Following CO₂ treatment, samples were depressurized to atmospheric pressure over the time indicated in Table 5. No vacuum infusion was used.

TABLE 6

| | Firming | Depressurization |
|---|---|---|
| Condition | compound | time |
| 2D-3 | 0.5% PME/ | 45 minutes |
| | 0.5% CaCl₂ | |
| 2D-4 | 1% PME/ | 60 minutes |
| | 1% CaCl₂ | |

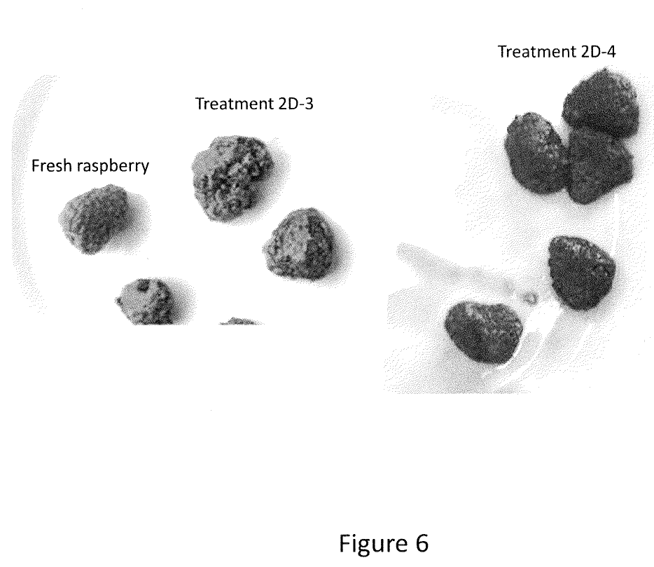

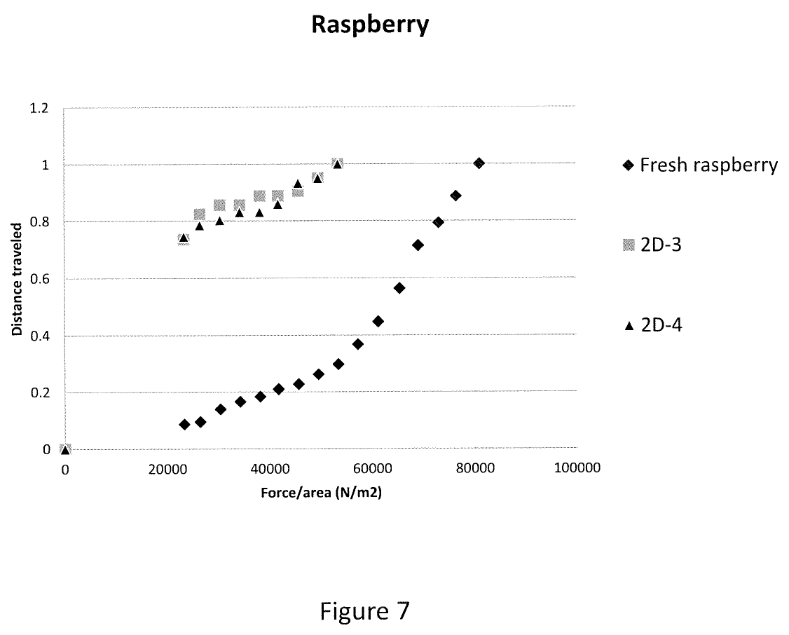

The second texture analysis method from Example 2 was used to produce FIG. 6. FIG. 6 shows fresh raspberries and raspberries treated according to Table 6. As can be seen in FIG. 6, treatment condition 2D-4 produced a more plump looking raspberry than treatment condition 2D-3. Similarly, as can be seen in FIG. 7, treatment condition 2D-4 produced treated raspberries with texture properties that most closely resembled the fresh raspberry control.

### Example 6

Microbial load reduction on diced strawberries was measured following CO₂ treatment. Briefly, an inoculation mixture containing 1×10⁸ cfu/ml of Listeria innocua (DSM-20649), 1×10⁶ cfu/ml of vegetative cells of Byssochlamys fulva (DSM-1808), and 1×10⁸ cfu/ml of Escherichia coli (DSM-1103) was added to 200 g diced (10 mm) strawberries to result in a microbial load of approximately 1×10^{6.2} cfu L. innocua, 1×10^{6.2} E. coli, and 1×10^{4.2} B. fulva per gram strawberries. E. coli and L. innocua were selected as model bacteria to mimic the effects on bacterial pathogens. B. fulva was selected as a heat resistant fungus to provide an indication of the effect on other heat-resistant microorganisms.

The inoculated strawberries were treated using conditions as set forth in Table 7. Vacuum infusion was performed for 5 minutes at a pressure of −15 inches Hg. CO₂ treatment was done for all treatment conditions, except Vac+Heat, at the times, pressures, and temperatures indicated in Table 7 in a stainless steel chamber. Following CO₂ treatment, samples were depressurized to atmospheric pressure over 45 minutes. Vac+Heat treatment did not include CO₂ treatment, but following a vacuum treatment, the sample was treated at atmospheric pressure to a temperature of 35° C. for 60 minutes. Microbial loads in the fruit were measured following CO₂ treatment (or heat treatment in case of the Vac+Heat control) using standard procedures and compared to the microbial load following inoculation. The log reduction for each treatment is shown in Table 8. Where “>3”, “>4” or “>5” is indicated in Table 8, the number of cfu per gram was too low to count in the treated fruit.

TABLE 7

| | Firming | Vacuum | Carrier | CO₂ | CO₂ | CO₂ |
|---|---|---|---|---|---|---|
| Condition | Compound | Infusion | Liquid | Temp. | Press. | Time |
| 2B-1 | 0.5% PME/ | Yes | Water | 35° C. | 120 bar | 15 min. |
| | 0.5% CaCl₂ | | | | | |
| 2B-2 | 0.5% PME/ | Yes | Water | 35° C. | 120 bar | 30 min. |
| | 0.5% CaCl₂ | | | | | |
| 2B-3 | 0.5% PME/ | Yes | Water | 35° C. | 200 bar | 15 min. |
| | 0.5% CaCl₂ | | | | | |
| 2B-4 | 0.5% PME/ | Yes | Water | 45° C. | 120 bar | 15 min. |
| | 0.5% CaCl₂ | | | | | |
| Vac + | 0.5% PME/ | Yes | NA | NA | NA | NA |
| Heat | 0.5% CaCl₂ | | | | | |

TABLE 8

| Condition | E. coli | Listeria | B. fulva |
|---|---|---|---|
| 2B-1 | >5 | >4 | >3 |
| 2B-2 | >5 | >4 | 2.21 |
| 2B-3 | >5 | >4 | 0 |
| 2B-4 | >5 | >4 | >3 |
| Vac + | >5 | 2.18 | 0.16 |
| Heat | | | |

As can be seen in Table 8, while vacuum treatment alone or vacuum treatment with heat was not sufficient to reliably eliminate any of the microbes tested, CO₂ treatment generally reduced microbial load overall.

### Example 7

Strawberry pieces were treated according to Table 7 and samples were obtained to measure enzyme activity from each treatment. For each sample, an enzyme extract was produced by adding fruit to a sodium phosphate buffer (0.2 M sodium phosphate, 1% by weight Triton, and 4% by weight polyvinylpolypyrrolidone, pH 6.5) at a ratio of 1:2. The mixture was mixed with a hand blender until a homogeneous mixture was obtained. The samples were chilled for 2 to 3 minutes to reduce the impact of heat generation by the hand blender. The mixture was then centrifuged for 30 minutes at 3400×g at 20° C. The supernatant was used as the extract measure each of PME, PPO, POD, and PG as described below.

PPO analysis—100 μl supernatant was added to 1 ml demineralized water (pH 6.5) and 3 nil of 0.07 M catechol in 0.05 M sodium phosphate buffer (pH 6.5) solution. The absorbance of the mixture was measured at 420 nm and 25° C. for 6 minutes using a UV-visible Helios Omega Spectrophotometer (Thermo Scientific, Waltham, Mass., USA) every 10 seconds. The activity of PPO was measured as the change of absorbance per second.

POD analysis—2 ml supernatant was diluted with 3 ml of demineralized water. The mixture was kept at a pH of 6.5. The POD activity was analyzed by adding 0.1 ml of the diluted supernatant to 2.2 ml of 1% (v/v) guaiacol (dissolved in 0.2 M sodium phosphate buffer, pH 6.5) and 0.2 ml of 1.5% H₂O₂ solution. The absorbance of the mixture was measured at 470 nm and 25° C. for 6 minutes using a UV-visible Helios Omega Spectrophotometer every 4 seconds. The activity of the POD was measured as the change in absorbance per second.

PME analysis—Consumption of NaOH in an extract/pectin mixture was used to measure PME activity. Consumption of NaOH in reference extract from fresh fruit was considered 100% activity. Briefly, the volume of NaOH used to bring a pectin solution to pH 7.5 was recorded. Following the addition of extract with the pectin solution, the solution was maintained at 30° C. The volume of NaOH required to maintain the reaction at pH 7.5 over 30 minutes was compared to the reference extract.

PG analysis—PG activity cuts polysaccharide into pieces, with each cut resulting in an additional sugar with a reducing end. The increase in reducing ends is measured to determine PG activity. Briefly, enzyme extract is mixed with a substrate solution of polygalacturonic acid and incubated for 5 minutes at 37° C. Absorbance was then measured at 410 nm. PAHBAH (p-hydroxybenzoic acid hydrazide) reagent was added for determination of carbohydrate reducing ends, and incubated at 97° C. for 5 minutes. PG activity was determined according to a standard calibration curve of galacturonic acid (0.02 g/ml to 0.10 g/ml).

TABLE 9

| | PME % | POD % | PPO % | PG % |
|---|---|---|---|---|
| | activity | activity | activity | activity |
| Condition | reduction | reduction | reduction | reduction |
| 2B-1 | 45 ± 1 | 32 ± 2 | 46 ± 28 | 29 |
| 2B-2 | 50 ± 3 | 38 ± 2 | 45 ± 28 | 42 |
| 2B-3 | 31 ± 6 | 31 ± 8 | 16 ± 16 | 32 |
| 2B-4 | 47 ± 1 | 21 ± 2 | +29 ± 1 | 43 |
| Vac | 11 ± 9 | 0 ± 5 | 33 ± 28 | 7 |
| Vac + | 7 ± 4 | 20 ± 6 | 18 ± 28 | 26 |
| Heat | | | | |

As shown in Table 9, although enzyme activity levels varied widely across repetitions of similar samples, it appears that CO₂ treatment reduced PME, POD, PPO, and PG activity. As compared to vacuum treatment alone or vacuum plus heat, CO₂ treatment also appeared to reduce each of the tested enzymes to a greater degree.

### Example 8

Fresh strawberries were washed and diced into 8 pieces each of no more than 12 mm. Batches of 200 g diced strawberries in 200 g liquid carrier (water) were subjected to one of the treatments set forth in Table 10. Following CO₂ treatment, samples were depressurized to atmospheric pressure over 30 minutes, and the fruit and carrier fluid were immediately separated and collected.

TABLE 10

| | CO₂ Temp | CO₂ pressure | Duration |
|---|---|---|---|
| Condition | (° C.) | (bar) | (minutes) |
| 8A | 35 | 100 | 15 |
| 8B | 40 | 100 | 15 |
| 8C | 45 | 100 | 15 |

Table 11 shows the hue and lightness values for the carrier fluid collected from each treatment condition. As can be seen, each condition resulted in a carrier fluid that contains measurable natural color. Also, red values in the collected carrier fluids increase as treatment temperature increases.

TABLE 11

| | | Red/green | Blue/yellow |
|---|---|---|---|
| Condition | Lightness | value | value |
| 8A | 59.45 | 26.1 | 28.34 |
| 8B | 57.46 | 28.21 | 29.24 |
| 8C | 57.26 | 28.91 | 28.81 |

### Example 9

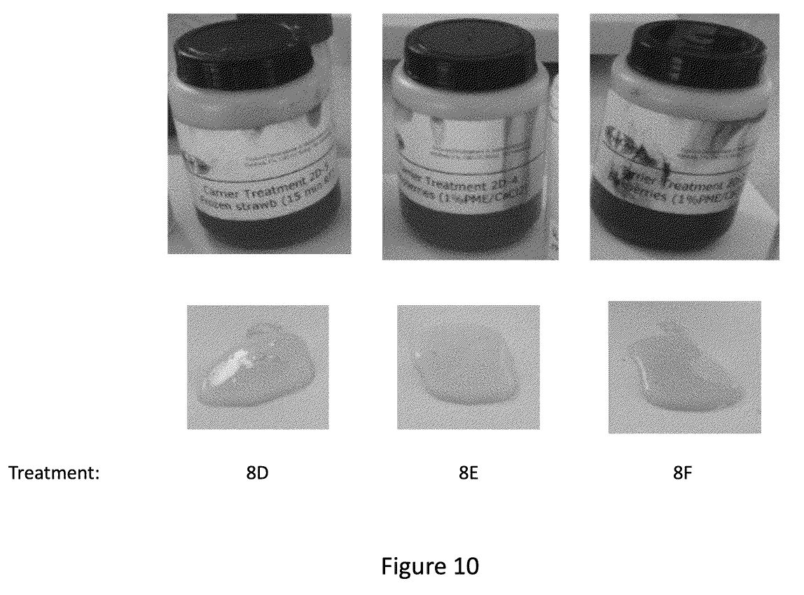

Strawberries, raspberries, and blueberries were treated according to the conditions in Table 12. Following treatment, the carrier fluid from each treatment was recovered and placed in a container. The carrier fluid was then added to a yogurt white mass at a ratio of 15 parts carrier fluid to 85 parts yogurt. FIG. 10 shows carrier fluid from each treatment (above) and the white mass including carrier fluid placed on a white sheet of paper (below). As can be seen in FIG. 10, each carrier fluid had significant natural color content, which could be used to visibly color the yogurt white mass, even without concentrating the natural color.

TABLE 12

| | | Pre- | | | |
|---|---|---|---|---|---|
| | | treatment | Carrier | CO₂ Treatment | Depressurization |
| Condition | Fruit | Infusion | Fluid | (Time/Temp/Pressure) | Time |
| 8D | Frozen | 0.5% PME/ | Water | 15 min/35° C./120 bar | 45 min |
| | strawberries:sugar | 0.5% CaCl₂ | | | |
| | (7:1) | | | | |
| 8E | Fresh | 0.5% PME/ | 1% PME/ | 15 min/35° C./120 bar | 60 min |
| | raspberries | 0.5% CaCl₂ | 1% CaCl₂ | | |
| 8F | Fresh | None | 1% PME/ | 15 min/35° C./120 bar | 60 min |
| | blueberries | | 1% CaCl₂ | | |

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of producing a treated fruit, comprising:
a) exposing a firming mixture to carbon dioxide at a pressure between 35 bar and 300 bar to form a treated fruit composition, the firming mixture including a combination of one or more fruit firming compounds and a fresh or frozen delicate fruit;
b) subjecting the firming mixture to a temperature greater than 0° C. and up to about 60° C.; and
c) depressurizing the treated fruit composition at a rate of depressurization selected to prevent substantial rupture of cell membranes to produce the treated fruit; wherein the treated fruit has a shelf life at 4° C. that is extended substantially beyond untreated fresh fruit of the same kind as the fresh or frozen fruit, and has a texture, color, or flavor that is improved compared to a control fresh or frozen fruit pasteurized using a thermal treatment alone or thermal treatment and a firming treatment over the shelf life at 4° C.

2. The method of claim 1, wherein the carbon dioxide is a supercritical fluid.

3. (canceled)

4. The method of claim 1, wherein the treated fruit is a whole fruit.

5. The method of claim 1, wherein the method is sufficient to achieve at least a 3 log reduction in E. coli or Listeria in the fruit.

6. The method of claim 1, wherein the pressure is between 50 bar and 150 bar.

7. The method of claim 1, wherein the depressurization step is done over a time period of 10 to 60 minutes.

8. The method of claim 1, wherein the treated fruit composition is depressurized to a pressure from atmospheric pressure less than 74 bar.

9. (canceled)

10. The method of claim 1, wherein the firming mixture is exposed to the carbon dioxide for 10 to 30 minutes.

11. The method of claim 1, wherein step b is performed during all or part of step a.

12. The method of claim 1, wherein the one or more fruit firming compounds is included in a carrier fluid.

13. (canceled)

14. The method of claim 1, wherein the one or more fruit firming compounds comprise pectin methyl esterase, calcium chloride, pectin, sugar, or a combination thereof.

15. (canceled)

16. The method of claim 1, further comprising, before steps a, b, and c:
d) exposing the fresh or frozen fruit to the one or more firming compounds and a carrier fluid; and
e) removing the carrier fluid.

17. The method of claim 16, wherein step d is performed under vacuum.

18. The method of claim 1, wherein the treated fruit maintains an improved texture over a shelf life at 4° C. of at least 3 weeks.

19-22. (canceled)

23. A treated fruit having a shelf life at 4° C. that is extended substantially beyond untreated fresh fruit of the same kind as the treated fruit, and has a texture, color, or flavor that is improved compared to a control fresh or frozen fruit pasteurized using a thermal treatment over the shelf life at 4° C.

24. The treated fruit of claim 23, wherein the treated fruit product has a shelf life of at least 3 weeks at 4° C.

25. The treated fruit of claim 23, wherein the treated fruit does not exhibit gelling over the shelf life.

26. The treated fruit of claim 23, wherein the treated fruit has a respiration rate, as measured by O₂ uptake, of less than 20% that of the untreated fresh fruit of the same kind.

27-31. (canceled)

32. A food product, comprising the treated fruit of claim 23 and a second food ingredient.

33. The food product of claim 32, wherein the second food ingredient is a fruit puree, a dairy product, or a grain-based product.

34. A food product, comprising the treated fruit of claim 23 in a fermented dairy product, wherein the treated fruit has a texture that is improved over a fresh fruit of the same kind in the same type of dairy product over a shelf life at 4° C. and at least 2 weeks in the fermented dairy product.

35-36. (canceled)

37. A food kit, comprising the treated fruit of claim 23 and a second food ingredient packaged together in separate containers or separate container compartments.

38. A method of collecting a natural color and/or flavor from a fruit, comprising:
a) exposing a fruit mixture to carbon dioxide at a pressure between 35 bar and 300 bar to form a treated fruit composition, the fruit mixture including a carrier fluid and a fresh or frozen delicate fruit;
b) subjecting the fruit mixture to a temperature greater than 0° C. and up to about 60° C.;
c) depressurizing the treated fruit composition at a rate of depressurization selected to prevent substantial rupture of cell membranes to produce the treated fruit; and
d) collecting the carrier fluid from the treated fruit composition, the carrier fluid including the natural color and/or flavor.

39. The method of claim 38, further comprising a step of concentrating the natural color and/or flavor.

40-41. (canceled)
